(19) United States
(12) Patent Application Publication
(10) Pub. No.: US 2007/0292168 A1
(43) Pub. Date: Dec. 20, 2007

(54) Elastic Roller For Electrophotography

(76) Inventors: Takashi Kuchiyama, Otsu-shi (JP); Jun Kamite, Otsu-shi (JP); Nagahiro Masuda, Otsu-shi (JP); Keizo Asaoka, Kobe-shi (JP)

Correspondence Address: BIRCH STEWART KOLASCH & BIRCH, PO BOX 747, FALLS CHURCH, VA, 22040-0747, US

(21) Appl. No.: 11/664,496

(22) PCT Filed: Sep. 30, 2005
(86) PCT No.: PCT/JP05/18131

§ 371 Date: Apr. 3, 2007

(30) Foreign Application Priority Data
Oct. 4, 2004 (JP) 2004-291914
Nov. 12, 2004 (JP) 2004-329195

(51) Int. Cl. G03G 15/08

(52) U.S. Cl. 399/286

(57) ABSTRACT

Disclosed is an elastic roller for electrophotography wherein bleeding of an unreacted material, a plasticizer and an additive from the elastic layer to the roller surface is suppressed. Also disclosed is an elastic roller for electrophotography having excellent durability for long use. Specifically disclosed is (1) an elastic roller for electrophotography comprising a metal supporting member, an elastic layer formed on the outer circumferential surface of the metal supporting member, and a coating film which is formed on the elastic layer using a styrene-based thermoplastic elastomer and/or an olefin-based thermoplastic elastomer and composed of at least one or more layers. Also disclosed is (2) an elastic roller for electrophotography having excellent durability for long use wherein “a styrene-based thermoplastic elastomer modified by an acid and/or an acid anhydride” and/or “an olefin-based thermoplastic elastomer modified by an acid and/or an acid anhydride” is used as the material for coating film which is formed on the outer circumferential surface of the elastic layer and composed of at least one or more layers.

### TECHNICAL FIELD

The present invention relates to an elastic roller for electrophotography preferably employed mainly for a developing machine of an apparatus such as a copying machine, a printer or a receiving apparatus of a facsimile adopting an electrophotographic system.

### BACKGROUND ART

Rollers in the said technical field are used in applications to a charge roller, a developing roller and a fixing roller of the electrophotographic system, and required characteristics vary with the respective applications. For example, the developing roller has a function of carrying toner to an electrostatic latent image carrier such as a photosensitive body. The developing roller is generally formed by concentrically stacking an elastic layer around a conductive shaft of SUS or an aluminum alloy and forming a coating layer on this elastic layer. In a general developing machine, toner stored in a toner container is supplied and carried onto the surface of the developing roller with a feed roller and pressed with a regulating member such as a regulating blade for contact electrification/frictional electrification, so that a thin toner layer is formed on the developing layer. This thin toner layer adheres to an electrostatic latent image formed on the surface of the photosensitive body for forming a toner image, thereby developing an image. A DC voltage or an AC voltage is generally applied to the developing roller, the feed roller and the regulating blade, in order to adjust the surface potentials thereof. A contact development system employing the surface of the developing roller in contact with the photosensitive body and a non-contact developing machine rendering the same non-contact are employed for the development. Such a developing roller is required (1) to properly bring the toner into contact electrification/frictional electrification, (2) to have proper elasticity for a case where the surface thereof is pressed by the regulating member or the toner, (3) to have proper toner releasability on the surface layer not to cause such a phenomenon, the so-called toner filming, that the toner sticks to the surface thereof, and (4) to be capable of maintaining stable characteristics without reduction in the quantity of toner electrification or roller resistance under high temperature/high humidity environment.

As a developing roller satisfying the aforementioned required characteristics,

Patent Document 1 describes a roller having a surface layer of polyurethane resin having a polyether skeleton formed on a conductive elastic layer.

Patent Document 1: Japanese Patent Laying-Open No. 09-292754

### DISCLOSURE OF THE INVENTION

### Problems to be Solved by the Invention

When the aforementioned roller having the surface layer composed of the polyurethane resin having the polyether skeleton is employed as a developing roller for a color LBP, remarkably excellent images are obtained in an initial stage while reduction of picture quality such as increase of white fogs is observed as the number of outputs increases. It is inferred that the picture quality lowers since a plasticizer, an unreacted component or an additive in an elastic layer bleeds on the surface on the surface of the elastic roller for electrophotography and the plasticizer or the unreacted component fixes toner or a component in the toner to the roller surface to change the surface state, and it is necessary to reduce bleeding onto the roller surface.

When the roller is used over a long period, the roller may be broken through separation of the coating layer or the like, and hence the coating layer and an outermost layer must hold sufficient adhesive strength to ensure long-term durability of the roller when the elastic layer and the coating layer or the outermost layer are provided.

### Means for Solving the Problems

The inventors of the present invention have made deep studies in order to solve the aforementioned problems, to find that the aforementioned reduction of the picture quality resulting from increase of the number of outputs can be remarkably suppressed by employing a coating layer containing a styrene-based thermoplastic elastomer and/or an olefin-based thermoplastic elastomer as the coating layer of an elastic roller for electrophotography and reach the present invention.

In other words, the present invention has the following contents:

An elastic roller for electrophotography comprising:

a metal supporting member,

an elastic layer formed on the outer circumferential surface of the supporting member, and

a coating layer composed of at least one or more layers formed on the elastic layer, characterized in that at least one layer of the said coating layer contains:

(A) styrene-based thermoplastic elastomeric resin and/or olefin-based thermoplastic elastomeric resin (invention 1), and the said elastic roller for electrophotography contains a compound having a urethane bond on the outermost layer (invention 5).

And, the elastic roller for electrophotography, characterized in that the elastic layer according to invention 1 is composed of a reactant of a hardenable composition essentially composed of:

(C) a polymer having at least one hydrosilylatable alkenyl group in molecules,

(D) a compound having at least two hydrosilyl groups in molecules,

(E) a hydrosilylation catalyst, and

(F) a conductivity imparter (invention 6).

The elastic roller for electrophotography characterized in that the hydrosilylatable alkenyl group of the said component (C) is contained in a molecular end (invention 7).

The elastic roller for electrophotography characterized in that the organic polymer of the said component (C) is an oxyalkylene-based polymer (invention 8).

The elastic roller for electrophotography characterized in that the said elastic roller for electrophotography is used in contact with toner (invention 9).

The present invention is also directed to an elastic roller for electrophotography, characterized in that

the said

coating layer composed of at least one or more layers formed on the elastic layer is

formed on the outer circumferential surface of the elastic layer, and

characterized in that the said (A) styrene-based thermoplastic elastomeric resin and/or olefin-based thermoplastic elastomeric resin is at least partially

modified by an acid and/or an acid anhydride (invention 2).

In other words,

it is an elastic roller for electrophotography comprising:

a metal supporting member,

an elastic layer formed on the outer circumferential surface of the metal supporting member, and

a coating layer composed of at least one or more layers formed on the outer circumferential surface of the elastic layer, characterized in that at least one layer of the said coating layer contains:

(A) styrene-based thermoplastic elastomeric resin and/or olefin-based thermoplastic elastomeric resin, and

said resin is at least partially modified by an acid and/or an acid anhydride

(invention 2).

The elastic roller for electrophotography, characterized in that the average acid concentration of the resin (A) in the said coating layer is 0.1 to 10 mgCH₃ONa/g (invention 3).

The elastic roller for electrophotography, characterized in that the said coating layer further contains:

(B) the following (B-1) and/or (B-2) (claim 4):

(B-1) styrene-based thermoplastic elastomeric resin not modified by an acid and/or an acid anhydride.

(B-2) olefin-based thermoplastic elastomeric resin not modified by an acid and/or an acid anhydride.

The elastic roller for electrophotography, containing a compound having a urethane bond on the outermost layer of the said elastic roller for electrophotography (claim 5).

The elastic roller for electrophotography, characterized in that the elastic layer according to invention 2 is composed of a reactant of a hardenable composition essentially composed of:

(C) an organic polymer having at least one hydrosilylatable alkenyl group in molecules,

(D) a compound having at least two hydrosilyl groups in molecules,

(E) a hydrosilylation catalyst, and

(F) a conductivity imparter (invention 6).

The elastic roller for electrophotography, characterized in that the hydrosilylatable alkenyl group of the said component (C) is contained in a molecular end (invention 7).

Characterized in that the organic polymer of the said component (C) is an oxyalkylene-based polymer (invention 8).

The elastic roller for electrophotography, characterized in that the said elastic roller for electrophotography is used in contact with toner (invention 9).

### EFFECTS OF THE INVENTION

As hereinabove described, it has been rendered possible to inhibit an unreactant, a plasticizer and an additive in an elastic layer body from bleeding on the roller surface when employing a styrene-based thermoplastic elastomer and/or an olefin-based thermoplastic elastomer as the coating layer.

As hereinabove described,

it is rendered possible to inhibit an unreactant, a plasticizer and an additive in an elastic layer body from bleeding on the roller surface and simultaneously attain excellent durability in long use when employing a coating layer characterized in that at least one layer of the coating layer contains (A) styrene-based thermoplastic elastomeric resin and/or olefin-based thermoplastic resin, and

the resin is at least partially modified by an acid and/or an acid anhydride.

Further, it is rendered possible to inhibit an unreactant, a plasticizer and an additive in an elastic layer body from bleeding on the roller surface and simultaneously attain excellent durability in long use when employing a coating layer characterized in that

the said coating layer further contains:

(B) the following (B-1) and/or (B-2):

(B-1) styrene-based thermoplastic elastomeric resin not modified by an acid and/or an acid anhydride.

(B-2) olefin-based thermoplastic elastomeric resin not modified by an acid and/or an acid anhydride.

### BEST MODES FOR CARRYING OUT THE INVENTION

Various representative modes of an elastic roller for electrophotography according to the present invention are now described.

FIG. 1 is a sectional explanatory diagram of an elastic roller 1 for electrophotography according to the present invention. This developing roller 1 is obtained by providing an elastic layer 3 on a conductive shaft 2 composed of SUS (stainless steel), SUM, an aluminum alloy or conductive resin having a diameter of about 1 mm to 25 mm and forming a coating layer 4 on this elastic layer 3.

According to the first aspect (invention 1) of the present invention, coating layer 4 may not be directly formed on the outer circumferential surface of elastic layer 3.

According to the second aspect (invention 2) of the present invention, coating layer 4 is directly formed on the outer circumferential surface of elastic layer 3.

The roller resistance of the roller having the coating layer is regulated to be in the range of 10⁴Ω to 10¹⁰Ω, preferably 10⁴Ω to 10⁸Ω.

The roller resistance of the roller, having the coating layer, after application of an outermost layer is regulated to be in the range of 10⁴Ω to 10¹⁰Ω, preferably 10⁴Ω to 10⁸Ω.

The roller resistance of the roller coated with a surface layer is regulated to be in the range of 10⁴Ω to 10¹⁰Ω, preferably 10⁴Ω to 10⁸Ω.

This is because a leakage current or the like arises from the surface of the developing roller if the roller resistance is less than 10⁴Ω, and toner filming or the like so easily takes place that the picture quality lowers if the roller resistance exceeds 10¹⁰Ω. This roller resistance value is a value measured by horizontally bringing the developing roller into contact with a metal plate, applying a load of 500 g to each of both ends of the said conductive shaft in the direction of the metal plate and applying a DC voltage of 100 volts between the shaft and the metal plate.

The main component of the coating layer according to the present invention is selected from a styrene-based thermoplastic elastomer and an olefin-based thermoplastic elastomer, which may be independently employed, or may be employed together.

The component (A) of the coating layer according to one aspect of the present invention contains styrene-based thermoplastic elastomeric resin having an acid and/or an acid anhydride in the structure. A substituent modifying the resin employed in the present invention, not particularly restricted, is preferably an acid and/or an acid anhydride, and particularly preferably has a carboxyl group or an acid anhydride thereof. Adhesive strength with respect to the elastic layer conceivably increases due to the presence of this functional group. When the outermost layer is provided on this coating layer, further, the adhesive strength between the coating layer and the outermost layer conceivably increases. It is possible to disperse an additive such as a conductivity imparter or various fillers in the resin due to the presence of this functional group, thereby simplifying resistance regulation and adjustment of the surface shape. This resin, which may be modified by a small quantity of acid, preferably has an average acid concentration of 0.1 to 10 mgCH₃ONa/g expressed in a numerical value measured by titrating a solution prepared by dissolving 1 g of resin with sodium methoxide. If the acid concentration is excessively low, the adhesive strength between the coating layer and the elastic layer and the outermost layer tends to lower.

As examples of the styrene-based thermoplastic elastomer of the component (A) having the acid and/or the acid anhydride, a styrene-butadiene copolymer and a hydrogen additive thereof, a styrene-isoprene copolymer and a hydrogen additive thereof, a styrene-2-methylpropene copolymer, a styrene-butadiene-isoprene copolymer and a hydrogen additive thereof and substances obtained by copolymerizing these polymers with ethylene and modifying the resultants by acids and/or acid anhydrides can be listed. While such a copolymer or copolymer rubber may be any of a random copolymer, a graft copolymer, an alternating copolymer and a block copolymer and the manufacturing process as well as the shape thereof are not particularly restricted, a block copolymer is preferably employed for obtaining excellent rubber elasticity, and a styrene-butadiene-styrene hydrogen additive (abbreviation: SBS), a styrene-isoprene-styrene hydrogen additive (abbreviation: SEPS), a styrene-ethylene-isoprene-styrene hydrogen additive (abbreviation: SEEPS), a styrene-ethylene-butadiene-styrene hydrogen additive (abbreviation: SEBS) and a substance obtained by modifying styrene-isobutylene-styrene (abbreviation: SIBS) by an acid and/or an acid anhydride can be listed as examples. A functional group may be substituted in the polymerized styrene monomer. The molecular weight of the styrene-based thermoplastic elastomer is 50,000 to 300,000 in number average molecular weight (GPC method, in terms of polystyrene), preferably 70,000 to 150,000 in view of rubber elasticity, mechanical strength and processibility. An elastomer having a molecular weight of less than 50,000 is inferior in rubber elasticity and mechanical strength, while that having a molecular weight exceeding 300,000 is inferior in solubility in a solvent and causes cracking in the coating layer after application. The styrene content is preferably 5 to 50 weight %, particularly preferably 15 to 30 weight %. The hardness so increases that it is difficult to form a film if the polystyrene content increases, while the solution viscosity so increases that processibility lowers if the content lessens.

Further, (B) styrene-based thermoplastic elastomeric resin not modified by an acid- and/or an acid anhydride and/or olefin-based thermoplastic elastomeric resin not modified by an acid and/or an acid anhydride may also be contained in the coating layer according to the present invention, if necessary. In this case, the ratio of the resin (B) contained in the resin component of the coating layer, though arbitrary, is preferably 0 to 90 weight %, particularly preferably 15 to 85 weight %. If the ratio of the resin (B) is excessively low, the film hardness easily increases and toner stress tends to increase to cause reduction of the quality. If the ratio of the resin (B) is excessively high, the adhesive strength lowers. Further, dispersibility of the conductivity imparter and the filler in the resin component of the coating layer tends to lower.

A styrene-butadiene copolymer and a hydrogen additive thereof, a styrene-isoprene copolymer and a hydrogen additive thereof, a styrene-2-methylpropene copolymer, a styrene-butadiene-isoprene copolymer and a hydrogen additive thereof and substances obtained by copolymerizing these polymers with ethylene can be listed as specific examples of the styrene-based thermoplastic elastomer. A block copolymer is preferably employed for obtaining excellent rubber elasticity, and a styrene-butadiene-styrene hydrogen additive (abbreviation: SBS), a styrene-isoprene-styrene hydrogen additive (abbreviation: SEPS), a styrene-ethylene-isoprene-styrene hydrogen additive (abbreviation: SEEPS), a styrene-ethylene-butadiene-styrene hydrogen additive (abbreviation: SEBS) and styrene-isobutylene-styrene (abbreviation: SIBS) can be listed as examples. A functional group may be substituted in the polymerized styrene monomer. The molecular weight of the styrene-based thermoplastic elastomer is 50,000 to 300,000 in number average molecular weight (GPC method, in terms of polystyrene), preferably 70,000 to 150,000 in view of rubber elasticity, mechanical strength and processibility. An elastomer having a molecular weight of less than 50,000 is inferior in rubber elasticity and mechanical strength, while that having a molecular weight exceeding 300,000 is inferior in solubility in a solvent and causes cracking in the coating layer after application. The styrene content is preferably 5 to 50 weight %, particularly preferably 15 to 30 weight %. The hardness tends to so increase that it is difficult to form a film if the polystyrene content increases, while the solution viscosity tends to so increase that processibility lowers if the content lessens.

An ethylene-propylene copolymer, an ethylene-propylene-1-butene copolymer, an ethylene-propylene-1-butene copolymer, an ethylene-hexene copolymer, an ethylene-propylene-5-ethylidenenorbornene copolymer, an ethylene-propylene-dicyclopentadiene copolymer and an ethylene-propylene-1,4-hexadiene copolymer can be listed as specific examples of the olefin-based thermoplastic elastomer. Such a copolymer may be any of a random copolymer, a block copolymer and a graft copolymer, and may be crosslinked with sulfur, peroxide or the like. The molecular weight of the olefin-based thermoplastic elastomer is 50,000 to 500,000 in number average molecular weight (GPC method, in terms of polystyrene), preferably 70,000 to 300,000 in view of rubber elasticity, mechanical strength and application properties. An elastomer having a molecular weight of less than 50,000 is inferior in rubber elasticity and mechanical strength, while that having a molecular weight exceeding 500,000 is inferior in solubility in a solvent and causes cracking in the coating layer after application. The ethylene content is 30 to 90 weight %, preferably 40 to 80 weight %.

Various additives such as a conductivity imparter and various fillers may be added to the resin composition constituting the coating layer if necessary, in view of resistance regulation, adjustment of the surface shape or adhesiveness to the elastic layer. In order to further improve the adhesiveness between the elastic layer composed of the hardenable composition and the coating layer according to the present invention, the coating layer is preferably formed after the surface of the elastic layer is processed with a primer. An arbitrary primer containing various coupling agents or an epoxy compound can be used as the primer in the present invention.

While the method of forming the coating layer according to the present invention is not particularly restricted, the coating layer can be formed by applying the resin composition constituting the coating layer onto the elastic layer formed around the conductive shaft in a prescribed thickness by a method such as spray coating, dip coating or roll coating and drying and hardening the same at a prescribed temperature. In this case, the coating layer may not be directly formed on the outer circumferential surface of the elastic layer according to the first aspect (invention 1) of the present invention. More specifically, a method dissolving the styrene-based thermoplastic elastomer and/or the olefin-based thermoplastic elastomer used as the said coating layer in a solvent so that the solid content is 3 to 20% and spraying or dip-coating the same is convenient. The used solvent is not particularly restricted so far as the thermoplastic elastomer mainly composing the employed coating layer is compatible therewith and toluene, xylene, hexane, methyl ethyl ketone, butyl acetate, ethyl acetate, N,N-dimethylformamide, isopropanol and water are specifically listed by way of illustration, while toluene, xylene or hexane which is a nonpolar solvent is preferably employed. The temperature for drying the coating layer is preferably 70 to 200° C., particularly preferably 70 to 160° C. in consideration of thermal stability of the coating layer. Drying may be insufficient if the drying temperature is lower than 70° C., while the inner elastic layer and the coating layer may be deteriorated if the temperature is higher than 200° C. The thickness of the coating layer, set to a proper value in response to the employed material, the composition and the application and not particularly restricted, is preferably 1 to 100 μm in general. Abrasion resistance so lowers that long-term durability tends to lower if the thickness is smaller than 1 μm. Such a problem tends to arise that wrinkles easily form or compressive strain increases due to the difference between the linear expansion coefficients of the coating layer and the elastic layer if the thickness is larger than 100 μm. In order to adjust the thickness of the coating layer, wet-on-wet coating may be performed by repeating a method such as spraying or dipping several times. According to the present invention, various additives such as a leveling agent may be added if necessary, in order to improve coatability of the coating layer solution.

While the method of forming the coating layer according to the present invention is not particularly restricted, the coating layer can be formed by applying the resin composition constituting the coating layer onto the outer circumferential surface of the elastic layer formed around the conductive layer (second aspect (invention 2) of the present invention) in a prescribed thickness by a method such as spray coating, dip coating or roll coating and drying and hardening the same at a prescribed temperature. More specifically, a method dissolving the styrene-based thermoplastic elastomer and/or the olefin-based thermoplastic elastomer used as the said coating layer in a solvent so that the solid content is 3 to 20% and spraying or dip-coating the same is convenient.

The used solvent is not particularly restricted so far as the thermoplastic elastomer mainly composing the employed coating layer is compatible therewith and toluene, xylene, hexane, methyl ethyl ketone, butyl acetate, ethyl acetate, N,N-dimethylformamide, isopropanol and water are specifically listed by way of illustration, while toluene, xylene or hexane which is a nonpolar solvent is preferably employed.

The temperature for drying the coating layer is preferably 70 to 200° C., particularly preferably 70 to 160° C. in consideration of thermal stability of the coating layer. Drying may be insufficient if the drying temperature is lower than 70° C., while the inner elastic layer and the coating layer may be deteriorated if the temperature is higher than 200° C.

The thickness of the coating layer, set to a proper value in response to the employed material, the composition and the application and not particularly restricted, is preferably 1 to 100 μm in general. Abrasion resistance so lowers that long-term durability tends to lower if the thickness is smaller than 1 μm. Such a problem tends to arise that wrinkles easily form or compressive strain increases due to the difference between the linear expansion coefficients of the coating layer and the elastic layer if the thickness is larger than 100 μm. In order to adjust the thickness of the coating layer, wet-on-wet coating may be performed by repeating a method such as spraying or dipping several times. According to the present invention, various additives such as a leveling agent may be added if necessary, in order to improve coatability of the coating layer solution.

The roller requires abrasion resistance when used as an elastic roller for electrophotography rotating in contact with another member, and hence an outermost layer containing a compound having a urethane bond excellent in abrasion resistance is preferably formed. The outermost layer, which must also have proper flexibility similarly to the coating layer, is preferably composed of a urethane resin composition mainly composed of resin having a polyether, polyester or polycarbonate skeleton from this point of view, and this may be blended resin of polyether urethane, polyester urethane and polycarbonate urethane or a urethane resin composition having a urethane bond and at least one skeleton selected from a group consisting of polyether, polyester, polycarbonate and polysiloxane in one molecule.

Various additives such as a conductivity imparter, various fillers and a coupling agent may be added to the resin composition constituting the outermost layer if necessary, in view of resistance regulation, adjustment of the surface shape or adhesiveness to the coating layer.

While the method of forming the outermost layer according to the present invention is not particularly restricted, the outermost layer can be applied by a method similar to that for the coating layer, and can be formed by applying the outermost layer in a prescribed thickness by a method such as spray coating, dip coating or roll coating and drying and hardening the same at a prescribed temperature. More specifically, a method dissolving resin used as the said outermost layer in a solvent so that the solid content is 5 to 20% and spraying or dip-coating the same is convenient. The used solvent is not particularly restricted so far as the resin mainly composing the employed outermost layer is compatible therewith, and methyl ethyl ketone, butyl acetate, ethyl acetate, N,N-dimethylformamide, toluene, isopropanol and water are specifically listed by way of illustration. Particularly when the coating layer is formed with urethane resin, N,N-dimethylformamide or N,N-dimethylacetamide is preferable in view of compatibility. The temperature for drying the outermost layer is preferably 70 to 200° C. Drying may be insufficient if the drying temperature is lower than 70° C., while the inner elastic layer may be deteriorated if the temperature is higher than 200° C. The thickness of the outermost layer, set to a proper value in response to the employed material, the composition and the application and not particularly restricted, is preferably 1 to 100 μm in general. Abrasion resistance so lowers that long-term durability tends to lower if the thickness is smaller than 1 μm. Such a problem tends to arise that wrinkles easily form or compressive strain increases due to the difference between the linear expansion coefficients of the outermost layer and the elastic layer if the thickness is larger than 100 μm. In order to adjust the thickness of the coating layer, wet-on-wet coating may be performed by repeating a method such as spraying or dipping several times. According to the present invention, various additives such as a leveling agent may be added if necessary, in order to improve coatability of the coating layer solution.

A hardened substance of a hardenable composition essentially composed of (C) an organic polymer having at least one hydrosilylatable alkenyl group in molecules, (D) a compound containing at least two hydrosilyl groups in molecules, (E) a hydrosilylation catalyst and (F) a conductivity imparter can be preferably used as the said elastic layer. The physical properties of the hardened substance can be easily controlled by varying the molecular weight and the functional group content of the said hardenable composition.

The alkenyl group of the organic polymer having at least one hydrosilylatable alkenyl group in molecules of the said component (C) is not particularly restricted so far as the same is a group containing a carbon-carbon double bond having activity with respect to hydrosilylation. As an exemplary alkenyl group, an unsaturated aliphatic hydrocarbon group such as a vinyl group, an allyl group, a methyl vinyl group, a propenyl group, a butenyl group, a pentenyl group or a hexenyl group, a cyclic unsaturated hydrocarbon group such as a cyclopropenyl group, a cyclobutenyl group, a cyclopentenyl group or a cyclohexenyl group or a methacryl group can be listed. Preferably, an alkenyl group expressed in the following general formula (I):
H₂C═C(R₁)—CH₂— (1) (in the formula, R₁ represents a hydrogen atom or a methyl group)
is particularly preferable in a point that the same is excellent in hardenability. As to the component (C), the aforementioned hydrosilylatable alkenyl group is preferably introduced into an end of the polymer. When the alkenyl group is present in the polymer end in this manner, the quantity of effective network chains of the finally formed hardened substance preferably so increases that a rubber-like hardened substance of high hardness can be easily obtained.

The main chain of the component (C) can be selected from arbitrary polymers, and is not particularly restricted. For example, polyisoprene, polybutadiene, polyisobutylene, polychloroprene, polyoxyalkylene, polysiloxane or polysulfide can be listed. In particular, a polymer composed of an oxyalkylene unit is easy to handle before hardening due to low viscosity, and preferable in such a point that the same sufficiently exhibits the elastic effect thereof also when the thickness is reduced since the hardened substance has a particularly flexible structure when the roller is used as an elastic roller.

The said oxyalkylene-based polymer used as the component (C) of the hardenable composition according to the present invention is such a polymer that at least 30%, preferably at least 50% of units constituting the main chain is composed of the oxyalkylene unit, and a unit from a compound, used as a starting material in manufacture of the polymer, having at least two active hydrogens such as ethylene glycol, a bisphenol-based compound, glycerin, trimethylolpropane or pentaerythritol can be listed as the unit contained in addition to the oxyalkylene unit. The oxyalkylene unit may not be of a single type, but a copolymer (including a graft copolymer) composed of ethylene oxide, propylene oxide and butylene oxide is also employable. The polymer is preferably composed of an oxypropylene unit or an oxybutylene unit having relatively low susceptibility to water as the main chain skeleton in environmental stability of electric characteristics, and a polymer composed of an oxypropylene unit is particularly preferable in consideration of the cost.

The molecular weight of the aforementioned polyoxyalkylene-based polymer is preferably 500 to 50,000 in number average molecular weight (GPC method, in terms of polystyrene) in view of handleability thereof and rubber elasticity after hardening. If the number average molecular weight is less than 500, sufficient mechanical characteristics (rubber hardness and percent elongation) are hardly obtained when this hardenable composition is hardened. If the number average molecular weight is at least 50,000, on the other hand, the molecular weight per alkenyl group contained in the molecules increases or reactivity is so reduced due to steric hindrance that hardening is generally insufficient, and viscosity tends to be excessively high to deteriorate processibility.

While a hardener which is the said component (D) may be a compound having at least two hydrosilyl groups in molecules, a large quantity of hydrosilyl groups easily remain in the hardened substance after hardening to result in voids or cracks if the number of hydrosilyl groups contained in the molecules is too large and hence the number thereof is preferably adjusted to not more than 50, and more preferably adjusted to 2 to 30 in view of control of rubber elasticity of the hardened substance or improvement of storage stability. In the present invention, possession of one hydrosilyl group means possession of one H bonded to Si. Therefore, it follows that the compound has two hydrosilyl groups in the case of SiH₂, H bonded to Si is preferably bonded to different Si, in view of hardenability and rubber elasticity.

The molecular weight of such a hardener is preferably adjusted to not more than 30,000 in number average molecular weight (Mn) in view of improvement of processibility of a molding, and more preferably adjusted to 300 to 10,000 in Mn in view of improvement of reactivity and compatibility to the aforementioned base polymer.

It is important that the aforementioned hardener has a phenyl radical-containing modified body in a point of compatibility considering that cohesion of the base polymer is larger as compared with the cohesion of the hardener, and a styrene modified body is preferable in a point of obtainability, while an α-methylstyrene modified body is preferable in view of storage stability.

The hydrosilylation catalyst which is the component (E) is not particularly restricted but an arbitrary one can be used. More specifically, a substance prepared by making a carrier such as chloroplatinic acid, a simple body of platinum, alumina, silica or carbon black carry solid platinum; a white-vinylsiloxane complex {for example, Ptₙ(ViMe₂SiOSiMe₂Vi)ₘ or Pt[(MeViSiO)₄]ₘ}; a platinum-phosphine complex {for example, Pt(PPh₃)₄ or Pt(PBu₃)₄}; a platinum-phosphite complex {for example, Pt[P(OPh)₃]₄ or Pt[P(OBu)₃]₄ (in each formula, Me represents a methyl group, Bu represents a butyl group, Vi represents a vinyl group, Ph represents a phenyl radical, and n and m represent integers), Pt(acac)₂, platinum-hydrocarbon composites described in the specifications of U.S. Pat. Nos. 3,159,601 and 3,159,662 to Ashby et al. and a platinum alkolate catalyst described in the specification of U.S. Pat. No. 3,220,972 to Lamoreaux et al. can be listed by way of illustration.

As examples of catalysts other than the platinum compound, RhCl(PPh₃)₃, RhCl₃, Rh/Al₂O₃, RuCl₃, IrCl₃, FeCl₃, AlCl₃, PdCl₂.2H₂O, NiCl₂, TiCl₄ etc. can be listed. These catalysts may be independently used, at least two types of such catalysts may be used. Chloroplatinic acid, a platinum-olefin complex, a platinum-vinylsiloxane complex or Pt(acac)₂ is preferable in view of catalytic activity. While the catalytic quantity is not particularly restricted, the catalyst is preferably employed in the range of 10⁻¹ to 10⁻⁸ mol with respect to 1 mol of the alkenyl group in the component (C). The catalyst is more preferably employed in the range of 10⁻² to 10⁻⁶ mol. in order to sufficiently progress hydrosilylation. The hydrosilylation catalyst, which is high-priced and corrosive and may generate a large quantity of hydrogen gas to foam the hardened substance, is preferably employed not in excess of 10⁻¹ mol.

As examples of the conductivity imparter of the component (F), carbon black, a metal oxide, metal impalpable powder, quaternary ammonium salt, an organic compound or polymer having a carboxylic group, a sulfonic group, a sulfate group or a phosphate group, an ether ester imide or ether imide copolymer, an ethylene oxide-epihalohydrin copolymer, a compound having a conductive unit represented by methoxypolyethylene glycol acrylate or the like and an antistatic agent such as a polymeric compound can be listed. The compound (F) in the present invention may be independently employed, or at least two types of components (F) may be employed. Furnace black, acetylene black, lamp black, channel black, thermal black and oil black can be listed as examples of the aforementioned carbon black. The type, the particle size etc. of this carbon black are not restricted.

The content of the component (F) is adjusted in response to desired conductivity, and the component (F) is preferably employed by 0.01 to 100 parts by weight, further by 0.1 to 50 parts by weight with respect to 100 parts by weight of the component (C). Developed conductivity-imparting ability is insufficient if the content is excessively small, while viscosity of the hardenable composition may remarkably increase to deteriorate the processibility if the content is excessively large. Hydrosilylation may be inhibited depending on the type or the content of the employed conductivity imparter, and hence influence of the conductivity-imparting substance on hydrosilylation is preferably taken into consideration.

According to the present invention, various fillers, various function imparters, an antioxidant, an ultraviolet absorber, a pigment, a surface-active agent and a solvent may be properly added if necessary. Silica impalpable powder, metal impalpable powder, calcium carbonate, clay, talc, titanium oxide, zinc white, diatomaceous earth, barium sulfate etc. can be listed as specific examples of the said fillers.

A storage stability improver can be used for the hardenable composition of the present invention, in order to improve storage stability. This storage stability improver may be an ordinary stabilizer known as a preservation stabilizer for the component (D) of the present invention attaining the intended object, and is not particularly restricted. More specifically, a compound containing an aliphatic unsaturated bond, an organic phosphorus compound, an organic sulfur compound, a nitrogen-containing compound, a tin-based compound or an organic peroxide can be preferably employed. Further specifically, 2-benzothiazolyl sulfide, benzothiazole, thiazole, dimethylacetylene dicarboxylate, diethylacetylene dicarboxylate, butyl hydroxytoluene, butyl hydroxyanisole, vitamin E, 2-(4-morphodinyldithio)benzothiazole, 3-methyl-1-butene-3-ol, acetylenic unsaturated group-containing organosiloxane, ethylenic unsaturated group-containing organosiloxane, acetylene alcohol, 3-methyl-1-butyl-3-ol, 3-methyl-1-pentyne-3-ol, diallyl fumarate, diallyl maleate, diethyl fumarate, diethyl maleate, dimethyl maleate, 2-pentenenitrile and 2,3-dichloropropene can be listed, while the examples are not restricted to these.

When the roller is used in application to a roller assembled into an image generating apparatus utilizing an electrophotographic system as in the present invention, ASKER-C hardness of the hardened substance composed of the said hardenable composition is preferably 20° to 80°, and preferably 30 to 70° particularly when the roller is applied to a developing roller carrying toner in contact with another member. Compressive strain increases due to excessively low hardness in a region of hardness lower than the said range, while large stress is unpreferably applied to the toner due to excessively high hardness in a region of higher hardness to the contrary.

The elastic roller composed of the hardenable composition according to the present invention is used by forming at least one elastic layer composed of the said hardenable composition around the conductive shaft. The method of forming an elastic layer of a rubber roller is not particularly restricted but a well-known method of molding various rollers can be employed. For example, a composition is molded in a die having a conductive shaft of SUS or the like set on the center by a molding method such as extrusion molding, press molding, injection molding, reactive injection molding (RIM), liquid injection molding (LIM) or cast injection molding and heated/hardened at a proper temperature for a proper time, for molding an elastic layer around the conductive shaft. As the method of manufacturing a conductive roller in the present invention, liquid injection molding is preferable in points of productivity and processibility if the hardenable composition for forming the elastic layer is liquid. In this case, the hardenable composition may be completely hardened after the same is semihardened, by separately providing a post-curing process.

### EXAMPLES

While the present invention is now described according to specific Examples, the present invention is not restricted to only the following Examples.

In an elastic roller for electrophotography according to each of these Examples and comparative examples, a substance prepared by processing the surface of an SUM material plated with Ni on a surface of 248 mm in length and 8 mm in outer diameter with a primer was employed as a metal supporting member.

### Example 1

(C) 500 g of allyl-terminal polyoxypropylene (trade name: Kaneka Silyl ACS003, by Kanegafuchi Chemical Industry Co., Ltd.),

(D) 33 g of polyorganohydrogensiloxane (trade name: ACX004C, by Kanegafuchi Chemical Industry Co., Ltd.),

(E) 0.30 g of bis(1,3-divinyl-1,1,3,3-tetramethyldisiloxane) platinum complex catalyst (platinum content: 3 wt. %, xylene solution),

(F) 70 g of 3030B (by Mitsubishi Chemical Industries Ltd.) as a conductivity imparter, and

0.20 g of dimethyl maleate for serving as a storage stability improver were mixed with each other and defoamed under reduced pressure (not more than 10 mmHg, for 120 minutes). A conductive elastic body layer of about 4 mm in thickness was formed on the outer periphery of the shaft by injecting the obtained composition into the die in which the said shaft was set, heating the same at 140° C. for 30 minutes along with the die and hardening the composition.

Then, a solution prepared by diluting 80 g of a styrene-based thermoplastic elastomer SEBS (trade name: SEPTON S8006, by Kuraray Co., Ltd.) with 1000 g toluene was applied onto the outer circumferential surface of the conductive elastic layer by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Example 2

A solution prepared by diluting 80 g of a styrene-based thermoplastic elastomer SEEPS (trade name: SEPTON S4033, by Kuraray Co., Ltd.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Example 3

A solution prepared by diluting 80 g of a styrene-based thermoplastic elastomer SEEPS (trade name: SEPTON S2007, by Kuraray Co., Ltd.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Example 4

A solution prepared by diluting 80 g of a styrene-based thermoplastic elastomer SEBS (trade name: TUFTEC H1041, by Asahi Kasei Chemicals Corporation) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Example 5

A solution prepared by diluting 80 g of an olefin-based elastomer (trade name: Toughmer A-4050S, by Mitsui Chemicals, Inc.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Example 6

A solution prepared by diluting 80 g of an olefin-based elastomer (trade name: Toughmer P-0280, by Mitsui Chemicals, Inc.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Example 7

A solution prepared by diluting 80 g of a styrene-based thermoplastic elastomer SEBS (trade name: SEPTON S8006, by Kuraray Co., Ltd.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, a solution prepared by diluting 80 g of polyether urethane (trade name: Y258, by Dainichiseika Colour & Chemicals Mfg. Co., Ltd.) with 500 g of methyl ethyl ketone and 500 g of N,N-dimethylformamide was applied onto the outer circumferential surface of the said coating layer by vertical dipping as the outermost layer, dried at 140° C. for 10 minutes, further vertically dipped from the direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed.

### Comparative Example 1

A solution prepared by diluting 80 g of polyether urethane (trade name: Y258, by Dainichiseika Colour & Chemicals Mfg. Co., Ltd.) with 500 g of methyl ethyl ketone and 500 g of N,N-dimethylformamide was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), deposits derived from the elastic roller were confirmed.

### Example 8

(C) 500 g of allyl-terminal polyoxypropylene (trade name: Kaneka Silyl ACS003, by Kaneka Corporation),

(D) 33 g of polyorganohydrogensiloxane (trade name: ACX004C, by Kaneka Corporation),

(E) 0.30 g of bis(1,3-divinyl-1,1,3,3-tetramethyldisiloxane) platinum complex catalyst (platinum content: 3 wt. %, xylene solution),

(F) 70 g of 3030B (by Mitsubishi Chemical Industries Ltd.) as a conductivity imparter, and

0.20 g of dimethyl maleate for serving as a storage stability improver were mixed with each other and defoamed under reduced pressure (not more than 10 mmHg, for 120 minutes). A conductive elastic body layer of about 4 mm in thickness was formed on the outer periphery of the shaft by injecting the obtained composition into the die in which the said shaft was set, heating the same at 140° C. for 30 minutes along with the die and hardening the composition.

Then, a solution prepared by diluting 80 g of an acid-modified styrene-based thermoplastic elastomer (trade name: TUFTEC M1913, quantity of acid modification: 10 mgCH₃ONa/g, by Asahi Chemical Industry Co., Ltd.) with 1000 g toluene was applied onto the outer circumferential surface of the conductive elastic layer by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, no peeling was observed. Also after the said elastic roller was set on the cartridge (EP-85 by Canon Inc.) for a color printer and printing was performed in correspondence to 30000 sheets, no peeling of the coating layer was observed.

### Example 9

A solution prepared by diluting 40 g of an acid-modified styrene-based thermoplastic elastomer (trade name: TUFTEC M1913, quantity of acid modification: 10 mgCH₃ONa/g, by Asahi Chemical Industry Co., Ltd.) and 40 g of a styrene-based thermoplastic elastomer SEBS (trade name; SEPTON S8006, by Kuraray Co., Ltd.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, no peeling was observed. Also after the said elastic roller was set on the cartridge (EP-85 by Canon Inc.) for a color printer and printing was performed in correspondence to 30000 sheets, no peeling of the coating layer was observed.

### Example 10

A solution prepared by diluting 8 g of an acid-modified styrene-based thermoplastic elastomer (trade name: TUFTEC M1913, quantity of acid modification: 10 mgCH₃ONa/g, by Asahi Chemical Industry Co., Ltd.) and 72 g of a styrene-based thermoplastic elastomer SEBS (trade name; SEPTON S8006, by Kuraray Co., Ltd.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, no peeling was observed. Also after the said elastic roller was set on the cartridge (EP-85 by Canon Inc.) for a color printer and printing was performed in correspondence to 30000 sheets, no peeling of the coating layer was observed.

### Example 11

A solution prepared by diluting 5 g of an acid-modified styrene-based thermoplastic elastomer (trade name: TUFTEC M1913, quantity of acid modification: 10 mgCH₃ONa/g, by Asahi Chemical Industry Co., Ltd.) and 75 g of a styrene-based thermoplastic elastomer SEBS (trade name: SEPTON S8006, by Kuraray Co., Ltd.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, no peeling was observed. While no peeling of the coating layer was observed also after the said elastic roller was set on the cartridge (EP-85 by Canon Inc.) for a color printer and printing was performed in correspondence to 10000 sheets, peeling of the coating layer was observed with printing corresponding to 3000 sheets.

### Example 12

A solution prepared by diluting 8 g of an acid-modified styrene-based thermoplastic elastomer (trade name: TUFTEC M1913, quantity of acid modification: 10 mgCH₃ONa/g, by Asahi Chemical Industry Co., Ltd.) and 72 g of an olefin-based thermoplastic elastomer (trade name: Toughmer P-0280, by Mitsui Chemicals, Inc.) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, no peeling was observed. Also after the said elastic roller was set on the cartridge (EP-85 by Canon Inc.) for a color printer and printing was performed in correspondence to 30000 sheets, no peeling of the coating layer was observed.

### Example 13

A solution prepared by diluting 40 g of an acid-modified styrene-based thermoplastic elastomer (trade name: TUFTEC M1913, quantity of acid modification: 10 mgCH₃ONa/g, by Asahi Chemical Industry Co., Ltd.) and 40 g of a styrene-based thermoplastic elastomer SEBS (trade name: SEPTON S8006, by Kuraray Co., Ltd) with 1000 g of toluene was applied onto the outer circumferential surface of a conductive elastic layer molded by a method similar to that in Example 1 by vertical dipping as a coating layer, dried at 140° C. for 10 minutes, further vertically dipped from a direction opposite to the dipped roller again by the said method, and dried at 140° C. for 30 minutes. Then, a solution prepared by diluting 80 g of polyether urethane (trade name: Y258, by Dainichiseika Colour & Chemicals Mfg. Co., Ltd.) with 500 g of methyl ethyl ketone and 500 g of N,N-dimethylformamide was applied onto the outer circumferential surface of the said coating layer by vertical dipping as the outermost layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, no peeling was observed. Also after the said elastic roller was set on the cartridge (EP-85 by Canon Inc.) for a color printer and printing was performed in correspondence to 30000 sheets, no peeling of the coating layer was observed.

### Comparative Example 2

A solution prepared by diluting 80 g of a styrene-based thermoplastic elastomer SEBS (trade name: SEPTON S8006, by Kuraray Co., Ltd.) with 1000 g of toluene was applied onto the outer circumferential surface of a conductive elastic layer molded by a method similar to that in Example 8 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), no deposits derived from the elastic roller were confirmed. When adhesive strength between the coating layer and the elastic layer was evaluated by a cross-cut adhesion test, peeling took place. After the said elastic roller was set on a cartridge (EP-85 by Canon Inc.) for a color printer and printing was performed in correspondence to 10000 sheets, peeling of the coating layer was observed.

### Comparative Example 3

A solution prepared by diluting 80 g of polyether urethane (trade name: Y258, by Dainichiseika Colour & Chemicals Mfg. Co., Ltd.) with 500 g of methyl ethyl ketone and 500 g of N,N-dimethylformamide was applied onto the outer circumferential surface of a conductive elastic layer molded by a method similar to that in Example 8 by vertical dipping as a coating layer, dried at 140° C. for 10 minutes, further vertically dipped from a direction opposite to the dipped roller again by the said method, and dried at 140° C. for 30 minutes. Then, the said elastic roller was set on a cartridge (EP-85 by Canon Inc.) for a color printer, and left in environment of 40° C. and 95% RH for one week. When the elastic roller was thereafter detached from the cartridge for observing deposits on the surface of the photosensitive substance with a metallograph (by Nikon Corporation), deposits derived from the elastic roller were confirmed. When adhesive strength between the coating layer and the elastic layer was evaluated by a cross-cut adhesion test, peeling took place. After the said elastic roller was set on a cartridge (EP-85 by Canon Inc.) for a color printer and printing was performed in correspondence to 10000 sheets, peeling of the coating layer was observed.

### BRIEF DESCRIPTION OF THE DRAWINGS

FIG. 1 is a block diagram of an image recording apparatus according to an embodiment of the present invention.

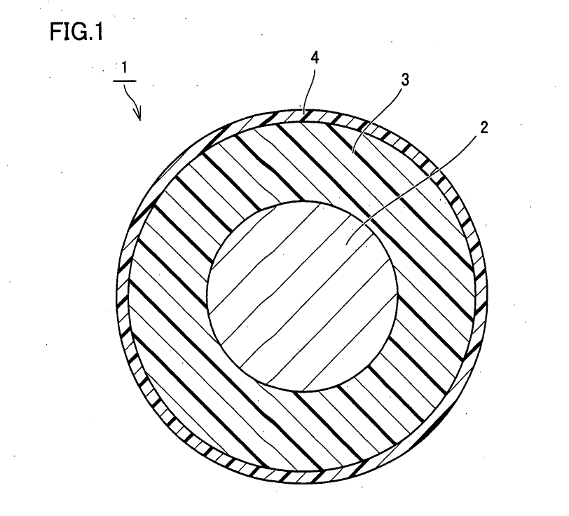

### DESCRIPTION OF REFERENCE NUMERALS

1 elastic roller for electrophotography (sectional view)
2 conductive shaft
3 elastic layer
4 coating layer

### INDUSTRIAL AVAILABILITY

It has been rendered possible to inhibit the unreactant, the plasticizer and the additive in the elastic layer body from bleeding on the roller surface when employing the styrene-based thermoplastic elastomer and/or the olefin-based thermoplastic elastomer as the coating layer.

As hereinabove described, it is rendered possible to inhibit the unreactant, the plasticizer and the additive in the elastic layer body from bleeding on the roller surface and simultaneously attain excellent durability in long use when employing the coating layer characterized in that at least one layer of the coating layer contains (A) styrene-based thermoplastic elastomeric resin and/or olefin-based thermoplastic resin and the resin is at least partially modified by an acid and/or an acid anhydride.

Further, it is rendered possible to inhibit the unreactant, the plasticizer and the additive in the elastic layer body from bleeding on the roller surface and simultaneously attain excellent durability in long use when employing the coating layer characterized in that the said coating layer further contains (B) the following (B-1) and/or (B-2):

(B-1) styrene-based thermoplastic elastomeric resin not modified by an acid and/or an acid anhydride.

(B-2) olefin-based thermoplastic elastomeric resin not modified by an acid and/or an acid anhydride.

1. An elastic roller for electrophotography comprising:
a metal supporting member;
an elastic layer formed on the outer circumferential surface of said metal supporting member; and
a coating layer composed of at least one or more layers formed on said elastic layer, wherein
at least one layer of said coating layer contains:
(A) styrene-based thermoplastic elastomeric resin and/or olefin-based thermoplastic elastomeric resin.

2. The elastic roller for electrophotography according to claim 1, wherein
said
coating layer composed of at least one or more layers formed on the elastic layer is formed on the outer circumferential surface of the elastic layer, and
said (A) styrene-based thermoplastic elastomeric resin and/or olefin-based thermoplastic elastomeric resin is at least partially modified by an acid and/or an acid anhydride.

3. The elastic roller for electrophotography according to claim 2, wherein
the average acid concentration of the resin (A) in said coating layer is 0.1 to 10 mgCH₃ONa/g.

4. The elastic roller for electrophotography according to claim 2, wherein
said coating layer further contains:
(B) the following (B-1) and/or (B-2):
(B-1) styrene-based thermoplastic elastomeric resin not modified by an acid and/or an acid anhydride.
(B-2) olefin-based thermoplastic elastomeric resin not modified by an acid and/or an acid anhydride.

5. The elastic roller for electrophotography according to claim 1, containing a compound having a urethane bond on the outermost layer of said elastic roller for electrophotography.

6. The elastic roller for electrophotography according to claim 1, wherein
the elastic layer according to claim 1
is composed of a reactant of a hardenable composition essentially composed of:
(C) an organic polymer having at least one hydrosilylatable alkenyl group in molecules,
(D) a compound having at least two hydrosilyl groups in molecules,
(E) a hydrosilylation catalyst, and
(F) a conductivity imparter.

7. The elastic roller for electrophotography according to claim 6, wherein
the hydrosilylatable alkenyl group of said component (C) is contained in a molecular end.

8. The elastic roller for electrophotography according to claim 6, wherein
the organic polymer of said component (C) is an oxyalkylene-based polymer.

9. The elastic roller for electrophotography according to claim 1, wherein
said elastic roller for electrophotography is used in contact with toner.
